(19) United States
(12) Patent Application Publication
(10) Pub. No.: US 2012/0316973 A1
(43) Pub. Date: Dec. 13, 2012

(54) SYSTEM, METHOD AND COMPUTER PROGRAM PRODUCT FOR ALLOWING AN EXPERT TO PROVIDE EXPERTISE

(75) Inventor: Jasen Fici, Columbia, MD (US)

(73) Assignee: DECISIONAIRE, LLC, Columbia, MD (US)

(21) Appl. No.: 13/159,211

(22) Filed: Jun. 13, 2011

(51) Int. Cl. G06N 5/02; G06Q 30/00

(52) U.S. Cl. 705/14.73; 706/46; 705/26.1

(57) ABSTRACT

Method, system, and computer program product for the allowing distribution of expertise by an expert to individual consumers, or multiple end users. The expertise is made available to the users who can apply the experts knowledge to their individual situation. The expert creates an intelligent questionnaire. Answers to questions are assigned values, which are then input to function(s) that represent the knowledge of the expert. The function's output is mapped to a narrative(s) or graphics, to create a conclusion(s). The conclusion(s) is presented to the end user. The questionnaire operates on a processor, which presents a user interface through which the end user may receive questions, provide answers, and receive conclusions. The expert may provide access to the intelligent questionnaire either directly to an end user, or through one or more intermediate parties. Access to the intelligent questionnaire may be provided for a fee.

### BACKGROUND

In any field of endeavor, there are people and organizations that have greater knowledge and experience than others. Such people and organizations may consider themselves experts. Often experts may want to share their expertise, either gratis or for a fee. From a consumer perspective, depending on the nature of the expertise, consumers may want access to this expertise. A novice tennis player, for example, may want the expertise of a tennis pro in selection of an appropriate racket. A family may want the expertise of a veterinarian in selecting a particular breed of dog. An engineering firm may want the expertise of a software developer when trying to develop a particular type of application program. Moreover, people may be willing to pay for this expertise.

Historically such expertise has been made available, but the existing mechanisms for doing so are inefficient. Online solutions have emerged, but are cumbersome and expensive to create and maintain. The development of an automated system for providing expertise may require extensive technical skill in areas such as software engineering, database creation and management, artificial intelligence, and user interface development. An expert typically does not have such skills. Technical personnel may be hired to create an automated expert system, but this may be prohibitively expensive. The expert wishing to develop such an automated system may therefore have to develop or purchase a skill set that is well outside his core competency. To field such a system, the expert needs to become a software developer. Moreover, such a system may have to be modified over time, as the best practices in the expert's field evolve. The system therefore needs to be maintained. This is also a costly proposition requiring the above technical skills, possibly on a recurring basis.

### SUMMARY

The present invention provides systems and methods for allowing an expert to provide expertise. In an exemplary system a host provider computer receives a questionnaire specification from the expert. The host provider computer creates an intelligent questionnaire on the basis of the questionnaire specification without requiring programming of the host provider computer by the expert. If access rights to the intelligent questionnaire are distributed by the expert, the end user is allowed access to the intelligent questionnaire.

In one aspect of the invention, allowing access to the intelligent questionnaire includes presenting, to the end user, questions in the intelligent questionnaire, receiving, from the end user, answers to the questions, associating an answer value to each of the answers, and applying, to the answer values, at least one function defined in the questionnaire specification.

In another aspect of the invention, the one or more conclusions are provided to either the end user or a user different than the end user.

### BRIEF DESCRIPTION OF THE DRAWINGS/FIGURES

Preferred and alternative examples of the present invention are described in detail below with reference to the following drawings:

FIG. 1 is a diagram illustrating the operation of an intelligent questionnaire, according to an embodiment of the invention;

FIG. 2 is a diagram illustrating creation of an intelligent questionnaire, according to an embodiment of the invention;

FIG. 3 is a flow chart illustrating the creation of an intelligent questionnaire, according to an embodiment of the invention;

FIG. 4 is a diagram illustrating the transfer of access rights to an intelligent questionnaire, according to an embodiment of the invention;

FIG. 5 is a diagram illustrating the transfer of access rights to an intelligent questionnaire given an intermediate buyer, according to an embodiment of the invention;

FIG. 6 is a flow chart illustrating the transfer of access rights to an intelligent questionnaire, according to an embodiment of the invention;

FIG. 7 is a flow chart illustrating the allocation of fees in the sale of access rights to an intelligent questionnaire, according to an embodiment of the invention;

FIG. 8 is a diagram illustrating a software or firmware embodiment of the invention; and

FIGS. 9-27 are screen shots of exemplary user interfaces formed in accordance with an embodiment of the present invention.

### DETAILED DESCRIPTION

An embodiment is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

The system and method described herein allows an expert to translate his or her knowledge and decision-making skill into an automated form, which can then be accessed by individual consumers, or end users. The expertise, as made available to an end user, is tailored to the individual end user's situation. An expert creates an intelligent questionnaire, which poses a set of questions to the end user. The answers to these questions are assigned values, which are then input to one or more functions that represent the reasoning and analysis of the expert. The output of the functions is mapped to predetermined narrative and/or graphical elements that are used to construct a conclusion. The conclusion is then presented to the end user. The conclusion is therefore articulated to the end user using text and/or graphics that are chosen dynamically on the basis of the outputs of the functions. In an embodiment of the invention, the intelligent questionnaire operates on a programmable processor, which presents a user interface through which the end user may receive questions, provide answers, and receive conclusions. The expert may provide access to the intelligent questionnaire either directly to an end user, or through one or more intermediate parties. Moreover, access to the intelligent questionnaire may be provided for a fee.

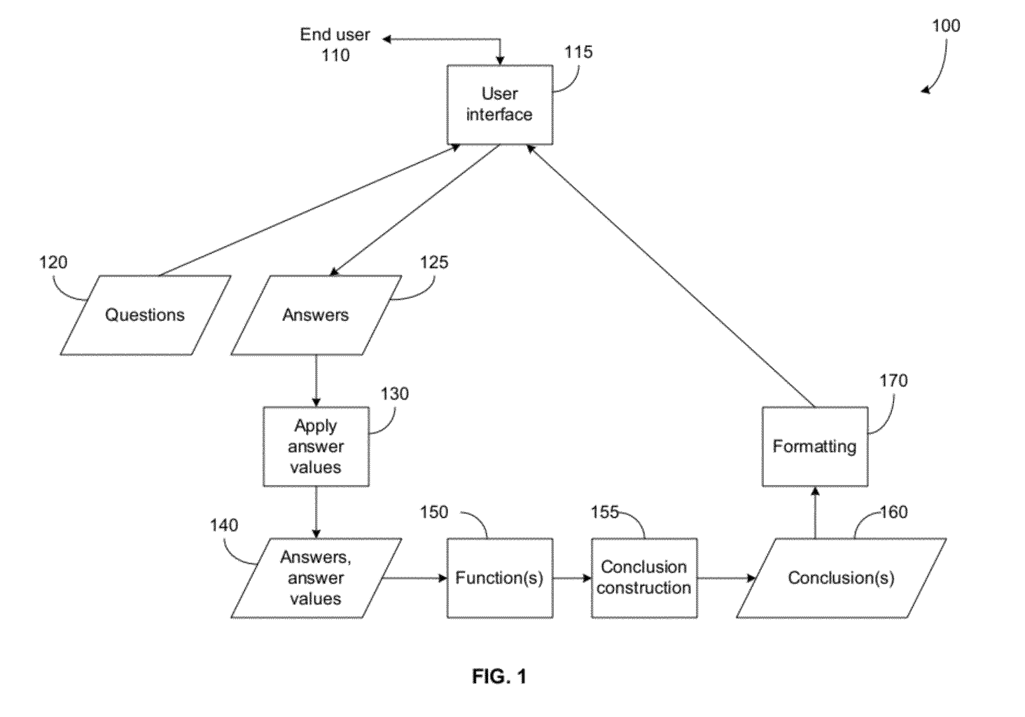

The operation of an intelligent questionnaire is illustrated in FIG. 1, according to an embodiment of the invention. The construction of an intelligent questionnaire will be described in greater detail below. In operation, an end user 110 interacts with the intelligent questionnaire 100 through a user interface 115. In an embodiment, the user interface 115 may be a graphical user interface. A series of questions 120 are provided to the end user 110 through the user interface 115. The end user 110 may provide answers 125 in response to questions 120. At 130, values are associated with each of the answers 125. These values are referred to herein as answer values. The answers and their associated answer values are shown as data 140 in the illustrated embodiment. One or more functions 150 are then applied to this data. The functions 150, as well as the answer values assigned to the particular answers 125 and the original questions 120, all reflect the knowledge and experience of an expert.

The output of functions 150 determines one or more conclusions 160. In an embodiment of the invention, a set of predetermined narrative elements and/or graphical elements is created during creation of the intelligent questionnaire. Furthermore, during the creation of the intelligent questionnaire, narrative and graphical elements in this set are associated with possible outputs of functions 150. After the end user answers the questions, one or more of functions 150 execute, yielding outputs. These outputs are used by conclusion construction module 155 to build conclusions 160. Depending on the output of functions 150, particular elements are chosen from this predetermined set of narrative elements and/or graphical elements and used to construct conclusions 160 for presentation to the end user. The conclusions 160 are therefore composed of predefined narrative and/or graphical elements that are selected dynamically on the basis of the outputs of functions 150.

The conclusions 160 may be presented to the end user 110 via the user interface 115. In the illustrated embodiment, conclusions 160 are first formatted by formatting 170 prior to presentation. In an embodiment of the invention, the user interface 115, the answer value application 130, functions 150, conclusion construction 155, formatting 170, and other logic are executed on a host provider computer, which the end user 110 accesses in order to use the intelligent questionnaire. The host provider computer may be operated and managed by a person or entity (i.e., a host provider) separate and distinct from the expert. Alternatively, the host computer may be operated and managed by the expert.

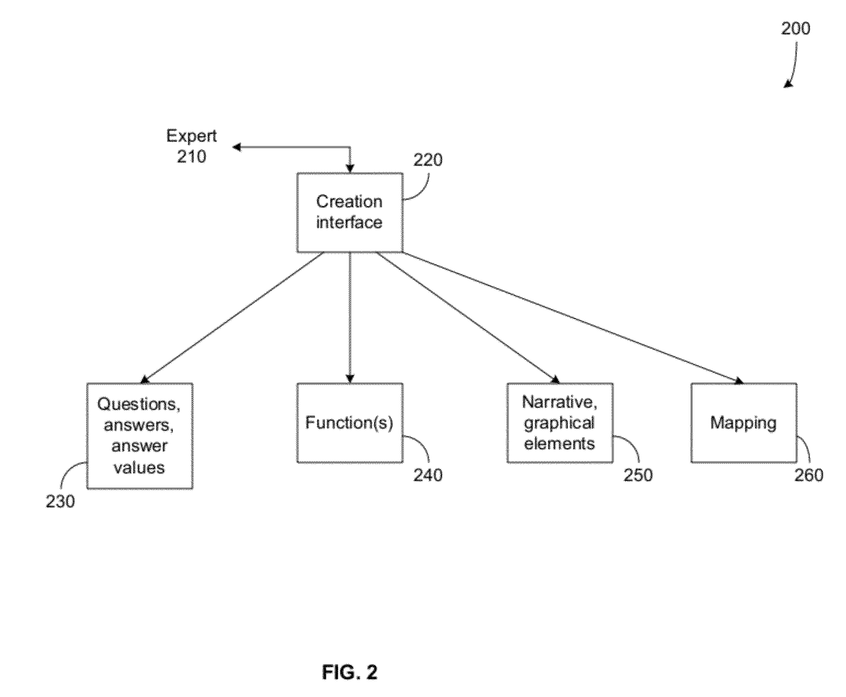

The creation of an intelligent questionnaire is illustrated in FIG. 2, according to an embodiment of the invention. An expert 210 serves as the creator of the intelligent questionnaire, and does so through a creator interface 220. The expert 210 determines questions and possible answers to those questions, and determines values associated with each of the possible answers. The answer values may be numerical. In various embodiments, some answer values may be binary or textual. The questions, answers, and answer values are entered by expert 210 into the creation interface 220 and stored as a body of data at block 230.

In an embodiment of the invention, the expert may also define and enter a format for the questions. In doing so, the expert may specify parameters such as the font of the questions' text, the area to be occupied by each question, and/or the use of graphics, for example. In an embodiment, the expert may also specify parameters for an answer interface (as part of the user interface), through which the end user is to respond to the questions, e.g., whether the end user is to click on a piece of text to select the text as an answer, or click on an adjacent dot, or check an adjacent box, the size and color of such a box, etc. In this way, the expert may partially or completely control the look and feel of the user interface 115. These are possible formats for questions and answers, and are not meant to be limiting. Some questions may be open-ended questions where the user may type in a value “Jasen” or a number, “5”, or a date “Jan. 1, 1980”.

The expert 210 also creates one or more functions 240 that use the answer values as inputs and generate one or more conclusions as outputs. These functions are entered by the expert 210 through the creator interface 220. In an embodiment, the functions are defined in terms of variables and logical and/or arithmetic operations performed on the variables. During operation of the intelligent questionnaire, the variables are assigned answer values, and conclusions are generated by executing the functions. Moreover, the functions may be nested, in that some functions may use, as inputs, the outputs of other functions.

In the illustrated embodiment, the expert 210 may also specify one or more narrative and/or graphical elements 250, to be used in articulating the eventual conclusions. The set of narrative and/or graphical elements 250 defined by the expert 210 may be viewed as a library of such elements. As discussed above, the outputs of functions 240 are mapped to the narrative and graphical elements 250, such that each of elements 250 corresponds to one or more particular outputs. During operation of the intelligent questionnaire, the narrative and/or graphical elements 250 that correspond to the function outputs are dynamically retrieved for use in constructing the conclusions. Mapping 260 between elements 250 and possible function outputs is also provided by the expert 210. The expert 210 may choose to have the conclusions presented as text, as one or more charts or graphs, or as some combination thereof, for example. The conclusion may be presented in any of a number of different ways. These options are all defined in the narrative and/or graphical elements 250. In addition, in embodiments of the invention, the expert 210 may specify particular fonts and text formats for textual reporting formats, and colors and shapes for graphical reporting formats. Moreover, the use of particular formats in the presentation of conclusions may depend on the conclusions themselves. Some conclusions may be presented as text; if different conclusions are reached, such conclusions may be presented in a graphical format for example.

Specification of narrative and/or graphical elements 250 takes place as follows. In an embodiment of the invention, the expert creates a set, or library, of narrative elements (e.g., blocks of sentences or phrases) and/or graphical elements (e.g., charts or diagrams or portions thereof). One or more particular elements are associated, by the expert, with each possible function output. This association is represented by mapping 260. After a function executes, its output is used to dynamically identify and retrieve the corresponding element(s) from the library, according to mapping 260. The resulting elements are then used to construct the conclusion(s) presented to the end user.

In embodiments of the invention, the expert may also specify, through the narrative and/or graphical elements 250 and mapping 260, that the original questions be repeated in the conclusions. Likewise, the expert may choose to have the function outputs presented to the end users as raw scores. This would also be specified in narrative and/or graphical elements 250 and mapping 260.

The information entered by the expert 210 in creation of the intelligent questionnaire, i.e., questions, answers, and answer values 230, functions 240, narrative and/or graphical elements 250, and the mapping 260 between possible function outputs and narrative and/or graphical elements 250, are collectively referred to herein as a questionnaire specification.

Note that conclusions are context dependent and user dependent. An end user seeking expertise may receive different conclusions in different contexts. If, for example, an end user is seeking restaurant recommendations, he will need different conclusions depending on his locale. In this case, different cities would require different conclusions. The library of narrative or graphical elements specified in narrative and/or graphical elements 250 may therefore require collaboration by several experts, each having localized expertise. In the above example, the library may include the names of possible restaurants; the library would necessarily have to include possibilities for an end user in Baltimore, and different possibilities for an end user in San Francisco. The library may therefore require the knowledge of two or more experts in such a case.

In some embodiments of the invention, conclusions may not be provided to individual end users. Instead, conclusions may be saved for each end user, and one or more collective conclusions may be generated and reported, reflecting the conclusions reached for all the individual end users. This would be useful when seeking expertise with respect to problems facing an organization or team, for example. Alternatively conclusions may be reported for both individual end users, and reported collectively for the larger set of end users.

In an embodiment of the invention, the creation interface 220 and the logic and storage associated with data 230-260 may reside on the host provider computer, which the expert 210 accesses either locally or remotely in order to create the intelligent questionnaire.

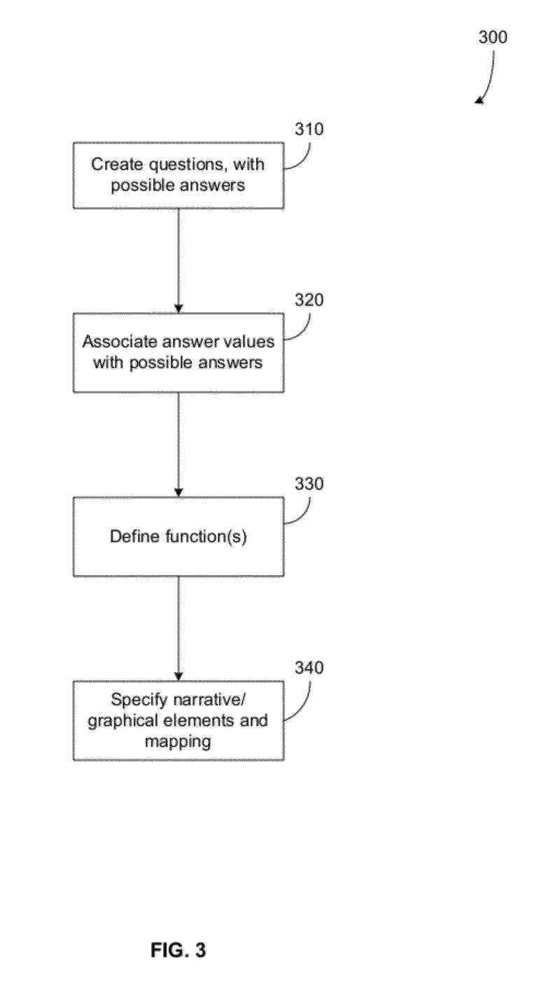

The process of creating an intelligent questionnaire is illustrated in FIG. 3, according to an embodiment of the invention. At 310, questions are created, along with possible answers for each question. At 320, answer values are associated with each of the possible answers. At 330, one or more functions are defined, where these functions produce outputs on the basis of the answer values. At 340, a library of one or more narrative and/or graphical elements is defined, as well as a mapping of possible function outputs to these elements. In operation, the particular graphical and/or narrative elements associated with the function outputs will be retrieved dynamically/automatically in the generation of one or more conclusions to be presented to the end user.

As noted above, the questions, answers, answer values, functions, narrative and/or graphical elements and a mapping between function outputs and these elements are determined by the expert. In an embodiment of the invention, this information is entered by the expert at the host provider computer on which the ultimate intelligent questionnaire is executed. The entry of the questionnaire specification may be done directly or remotely through a network connection. In an alternative embodiment, the expert may enter the information constituting the questionnaire specification at a first computer, producing the intelligent questionnaire. The intelligent questionnaire may then be moved to a different computer at which the questionnaire may be accessed and executed by an end user.

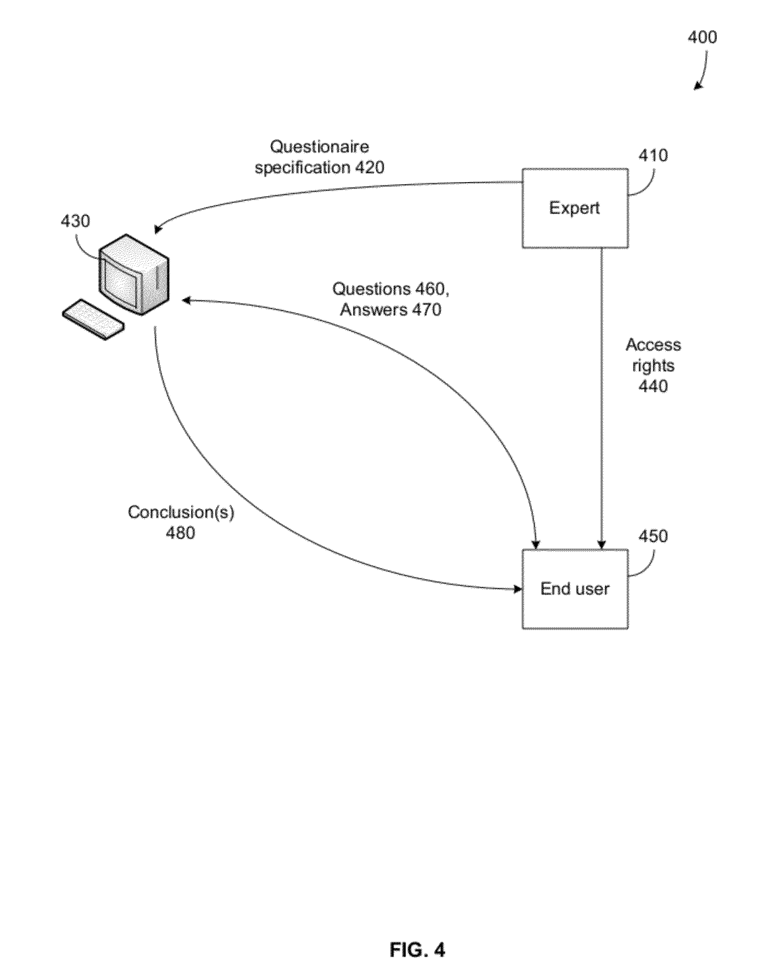

The flow of data and access rights is illustrated in FIG. 4, according to an embodiment of the invention. An expert 410 provides (via a web browser connected to the Internet) a questionnaire specification 422 to a host provider computer 430 in order to create the intelligent questionnaire. As described above, the questionnaire specification 420 defines various aspects of the intelligent questionnaire. Once created, the intelligent questionnaire can be made available to an end user 450. To enable this access, access rights 440 are transferred from the expert 410 to the end user 450. The access rights 440 are transferred via a unique uniform resource locator (url) which is provided to those granted rights. Someone may create rights for a reseller/distributor to use and in this case the url may be emailed. Rights may be granted to the general public with payment via credit card. In this case the url may be made available by simply posting to a website that anyone could get to. When the url is clicked it asks for payment. Rights, fees are associated with unique urls.

As noted above, the access rights 440 may be transferred in a sale to the end user 450. In an embodiment of the invention, any fee paid by the end user 450 is shared by both the expert 410 and the host provider. After the access rights transaction is complete, the end user 450 can receive questions 460 from the intelligent questionnaire and provide answers 470. When the intelligent questionnaire executes, conclusions 480 are produced and presented to the end user 450.

The embodiment of FIG. 4 assumes that the person answering questions in the intelligent questionnaire is the same as the person seeing the conclusions. This may not always be true. In alternative embodiments, these may be two distinct parties. An intelligent questionnaire may be used by a group or organization, for example, where individuals provide answers to the questions, but conclusions are presented only to a leader or representative of the group or organization.

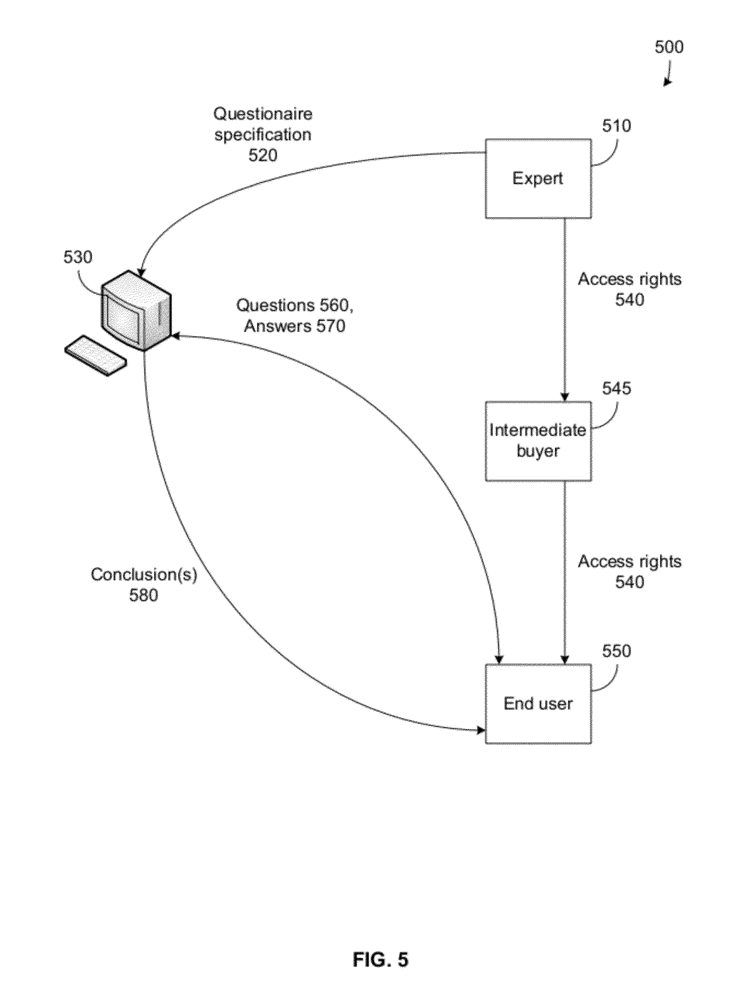

The transaction between the expert and the end user may not be direct. An example of such an embodiment is shown in FIG. 5. This is similar to the embodiment of FIG. 4, except that the access rights pass from the expert to the end user through an intermediate buyer 545. As in the previous case, an expert 510 provides questionnaire specification 520 to a host computer 530. As described above, the questionnaire specification 520 defines features of an intelligent questionnaire. Once created, the intelligent questionnaire can be made available to an end user 550. To enable this, access rights 540 are transferred from the expert 510 to the end user 550 via the intermediate buyer 545. The intermediate buyer 545 may be a distributor, broker, or agent for the expertise of the expert 510, for example. As noted above, the access rights 540 may be transferred in a sale. In an embodiment of the invention, the fee paid by the end user 550 may be shared among the intermediate buyer 545, the expert 510, and the host provider. After the access rights transaction is complete, the end user 550 can receive questions 560 from the intelligent questionnaire and provide answers 570. When the intelligent questionnaire executes, conclusions 580 are produced and presented to the end user 550. Note that, as discussed above, in alternative embodiments the person who answers the questions of the intelligent questionnaire may not be the same as the person to whom conclusions are presented.

In an embodiment of the invention, access to an intelligent questionnaire may be marketed in an on-line market (i.e., a website hosted by a server over a public or private data network), where a prospective end user may come to purchase the expertise therein. In such an embodiment, the expert may have several intelligent questionnaires available for the prospective end user. One example might be a golf pro, who makes expertise available on a number of issues, such as how to choose clubs, how to choose shoes, and how to avoid slicing a tee shot. Each of these issues may have a different intelligent questionnaire that can be used for a fee. Such an on-line market may also have intelligent questionnaires available from other experts in the same field and addressing the same issues. Such a market may also have questionnaires available on other topics (e.g., personal finance, cooking, gardening, career counseling, etc.).

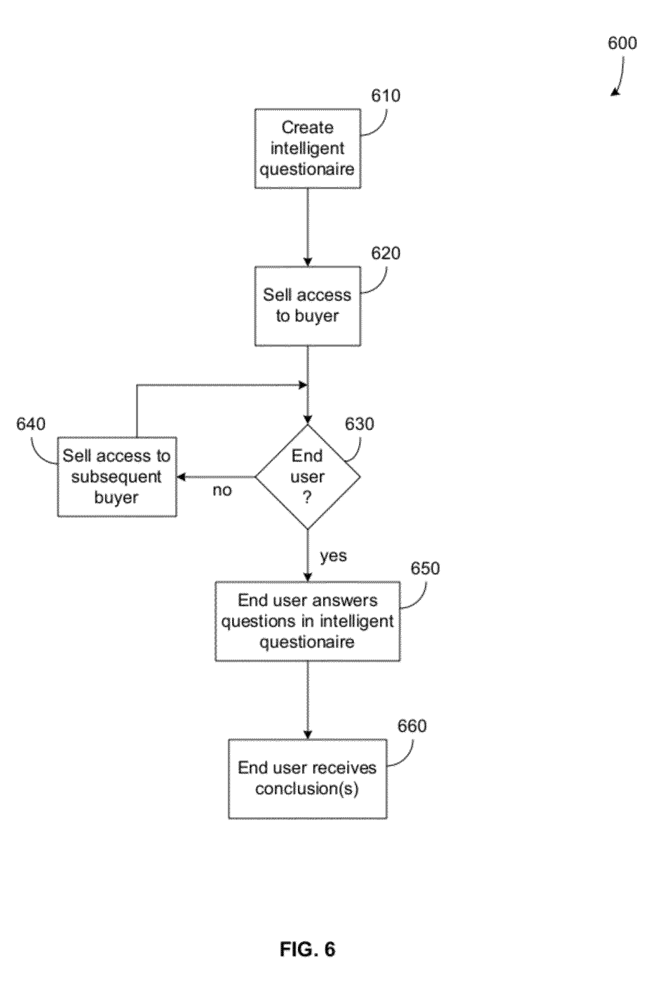

An exemplary process of providing expertise, as embodied in an intelligent questionnaire, is illustrated in FIG. 6, according to the embodiment of the invention. At block 610, an intelligent questionnaire is created by the expert. At block 620, access to the intelligent questionnaire is sold by the expert to a buyer. At decision block 630, if the buyer is an end user, the process is continued at block 650. Here, the end user answers the questions in the intelligent questionnaire. At block 660, the end user receives one or more conclusions on the basis of the answers provided.

In an embodiment of the invention, the buyer at block 620 may not be the end user, as noted above. Rather, the buyer may be an intermediate buyer. If this is the case, at block 640 the intermediate buyer may re-sell the access to a subsequent buyer. At decision block 630, the process 600 determines whether this subsequent buyer is the end user. If so, then the end user may proceed to interact with the intelligent questionnaire at blocks 650 and 660. Note that in various embodiments of the invention, there may be a series of several intermediate buyers involved before access to the intelligent questionnaire is ultimately sold to a subsequent buyer that is an end user. In embodiments where one or more intermediate buyers are present, portions of the fee paid by the end user may be allocated to some or all of the intermediate sellers, and/or to the host provider.

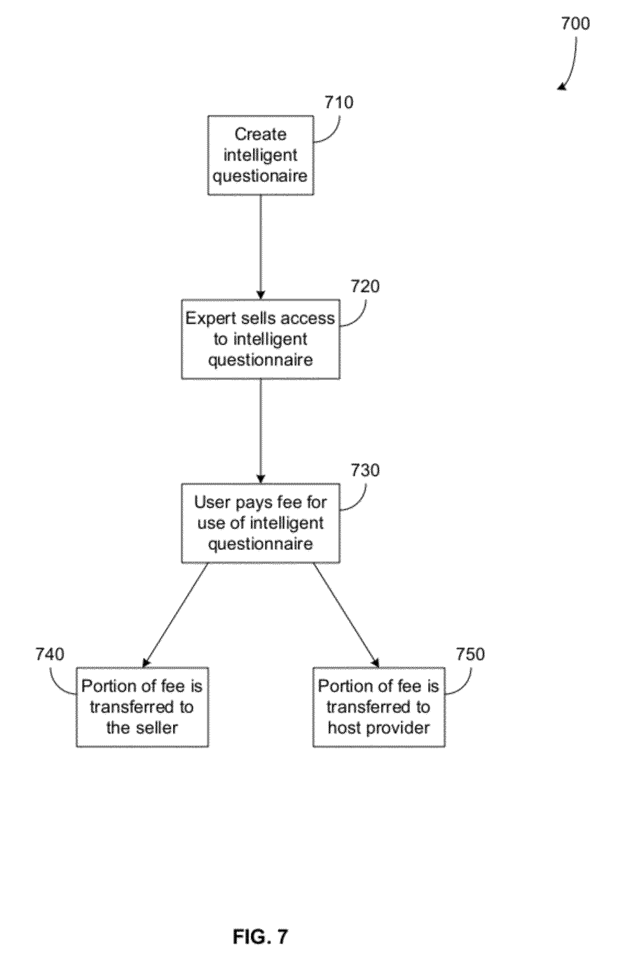

The financial transaction associated with distribution of access rights to an intelligent questionnaire is illustrated in FIG. 7, according to an embodiment of the invention. At block 710, the intelligent questionnaire is created at the computer of a host provider. At block 720, the expert sells access to the intelligent questionnaire. At block 730, the end user pays a fee for use of the intelligent questionnaire. At block 740, a first portion of the fee is transferred to the expert using a financial service, for example PayPal™. At block 750, a second portion of the fee is transferred to the host provider. As noted above, in alternative embodiments, the expert may not sell access rights directly to an end user. If one or more intermediate buyers are involved in the transaction, then each intermediate buyer, in addition to the host provider, may receive a portion of the fee paid by the end user.

In an embodiment of the invention, the expert may exercise considerable control over the particulars of selling access. The expert may define who may access an intelligent questionnaire, the rights granted (e.g., end use versus redistribution, or access to the intelligent questionnaire versus access to conclusions only), the fees imposed, the frequency and manner of fee assessment (e.g., charging per use, or for unlimited use, or some other model), etc.

One or more features disclosed herein may be implemented in hardware, software, firmware, or combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor or a fiber, through a local or wide area network, or through a network such as the Internet. An example of a non-transitory computer readable medium may be a compact disk, a flash memory, or other data storage device.

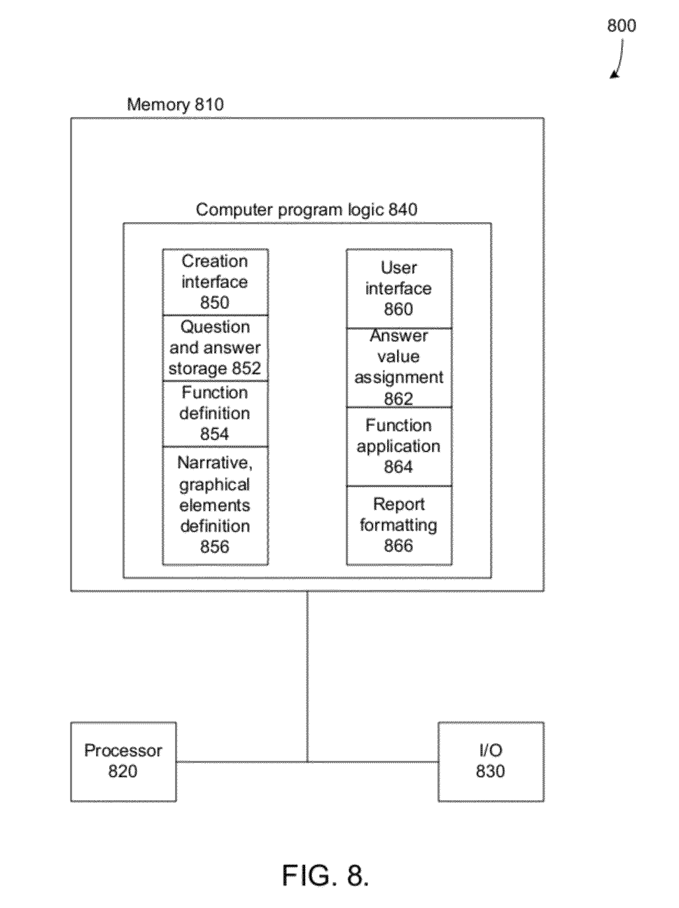

A software or firmware embodiment of the processing described above is illustrated in FIG. 8. An exemplary system 800 includes a programmable processor 820 and a memory device 810 that includes one or more computer readable media that store computer program logic 840. The memory device 810 may be implemented as one or more of a hard disk and drive, a removable media such as a compact disk and drive, flash memory, or a random access (RAM) or read-only memory (ROM) device, for example. The processor 820 and the memory device 810 may be in communication using any of several technologies known to one of ordinary skill in the art, such as a bus. The processor 820 may be a special purpose processor or a general purpose processor. The computer program logic 840 contained in memory 810 is read and executed by the processor 820. One or more I/O ports and/or I/O devices, shown collectively as I/O 830, are also connected to the processor 820 and the memory 810. In an embodiment such as that of FIG. 4 or 5, the system 800 may be incorporated in a host provider computer.

In an embodiment, the computer program logic 840 includes logic modules 850-866. In the illustrated embodiment, a creation interface module 850 represents the interface presented to an expert, allowing the expert to provide the questionnaire specification to the host provider computer. Through the creation interface module 850, the expert may input questions, possible answers to the questions, answer values for the possible answers, functions that operate on the answer values, and one or more desired formats for the conclusions presented to the end user, for example. A question and answer storage module 852 is responsible for storing the questions and answers provided by the expert. A function definition module 854 is responsible for using the function descriptions provided by the expert in the questionnaire specification and creating the corresponding executable logic. A narrative and/or graphical elements definition module 856 is responsible for receiving the library of narrative and/or graphical elements provided in the questionnaire specification and implementing the mapping between these elements and possible function outputs.

A user interface module 860 represents the interface presented to the end user, allowing the end user to see the questions of the intelligent questionnaire and provide answers to these questions. The conclusions generated by the intelligent questionnaire are also provided to the end user through the user interface module 860. An answer value assignment module 862 is responsible for associating answer values to the answers received from the end user. A function application module 864 is responsible for calling the functions needed to process the answer values for generation of the conclusions. A report formatting module 866 is responsible for formatting the conclusion(s) according to the format(s) specified by the questionnaire specification.

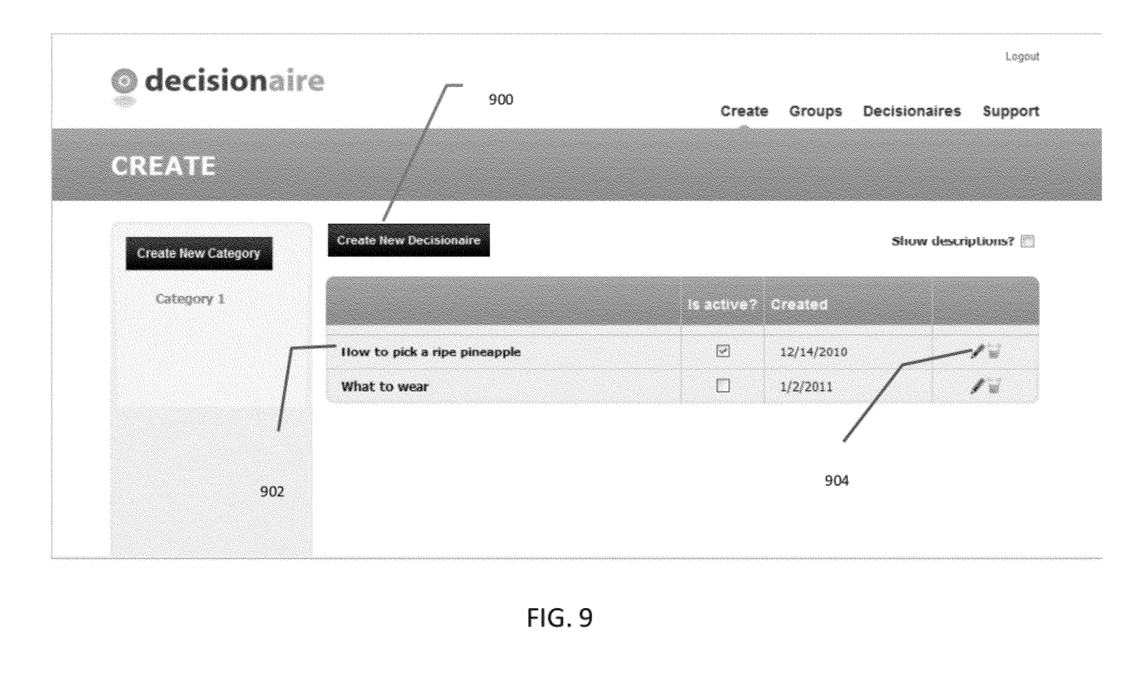

FIG. 9 shows a screen shot of an exemplary creation page that is accessible to a creator/author. The creator/author begins the creation of a decisionaire (or questionnaire) by activating a Create New Decisionaire button 900. The creation page shows a list of the decisionaires 902 that the author has created or is process of creating. By activating the titled listed in the list, the user is provided access to details about that questionnaire. The user can edit or delete the decisionaire by activating icons 904 associated with the title.

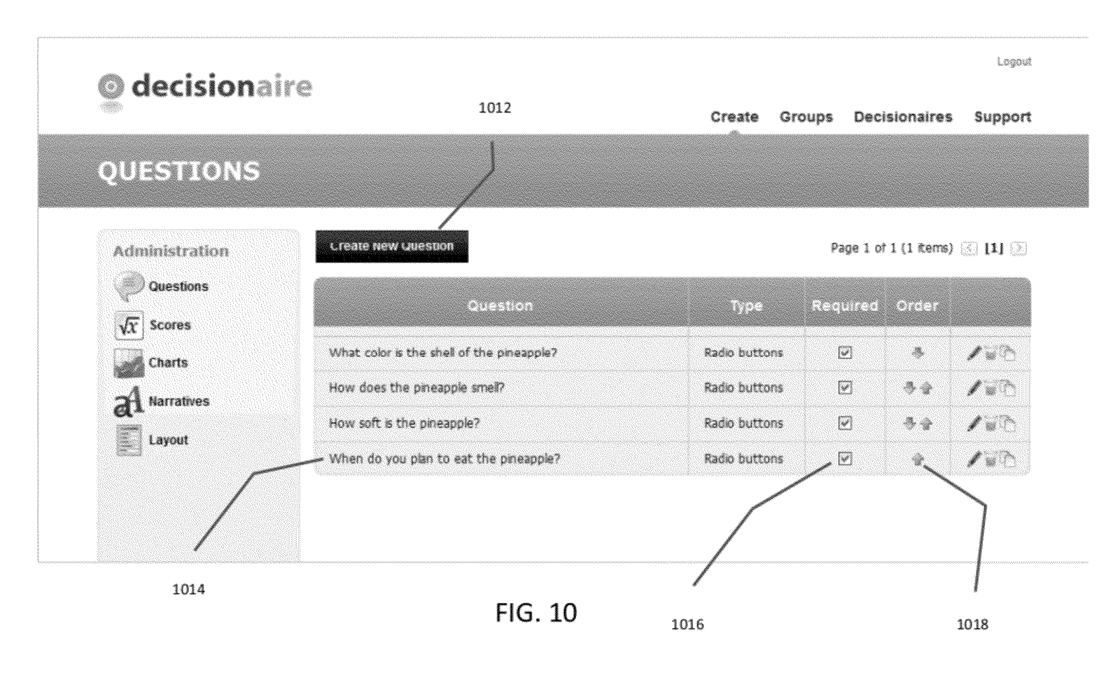

FIG. 10 shows a Questions screen that is presented after clicking the name of the decisionaire shown on FIG. 9. The Questions screen includes a list 1014 of created questions. The author creates questions by activating a Create New Question button 1012. The author can edit an existing question by activating an edit icon and can assign the order, using arrow icons 18, in which the questions are presented to an end user. A required column 1016 in the list 1014 identifies whether the question has been designated as being required to be answered.

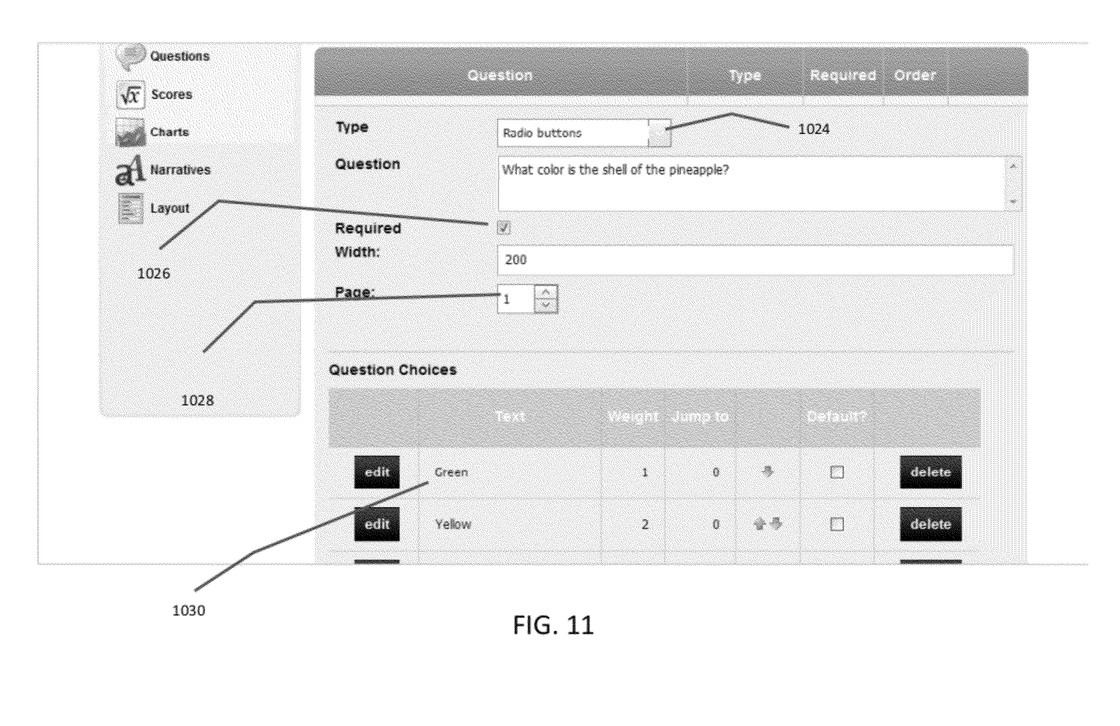

FIG. 11 shows an Edit/Create Questions screen that is presented after clicking the question edit icon or clicking the Create New Question button 1012 from the Questions screen. A type field 1024 allows the author to select the type of question. The following is a list of question types: Plain Text/HTML, Single-line Text Input, Multi-line Text Input, Drop-down List, Radio Buttons, Multi-Select. The Edit/Create Questions screen includes a section for entering the text of the question. A required check box 1026 allows the author to select whether the questioned is to be required. The Edit/Create Questions screen also includes a page indicator 1028 that allows the author to identify what page the question is to appear on in a multipage survey. At the bottom of the Edit/Create Questions screen is a list 1030 of the choices for the question shown above.

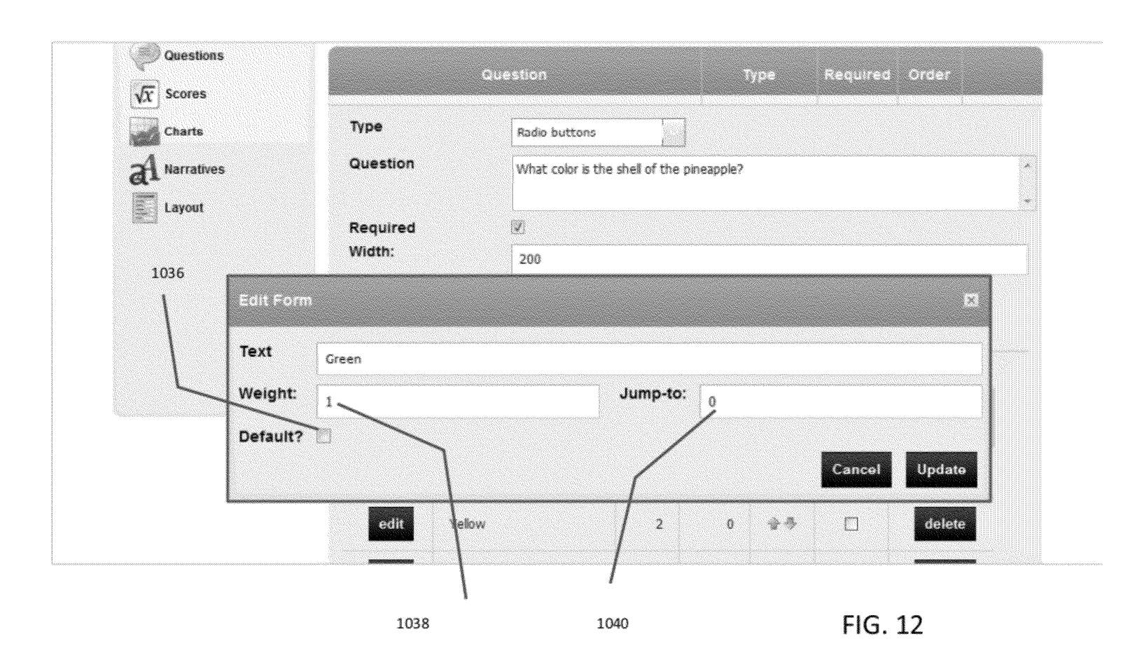

FIG. 12 shows an Edit/Create Answers to Questions screen that is presented after clicking an answer edit button or clicking a “create new choice” button that pops-up after selection of the edit button. The Edit/Create Answers to Questions screen allows the author to enter the answer/choice text and a numeric value associated with the specific answer/choice (weight) 38. A box 1036 when checked allows the author to identify this answer as the default answer. A Jump-to box 1040 allows the author to direct the decisionaire to another question if this answer is selected. The other question is identified by a number.

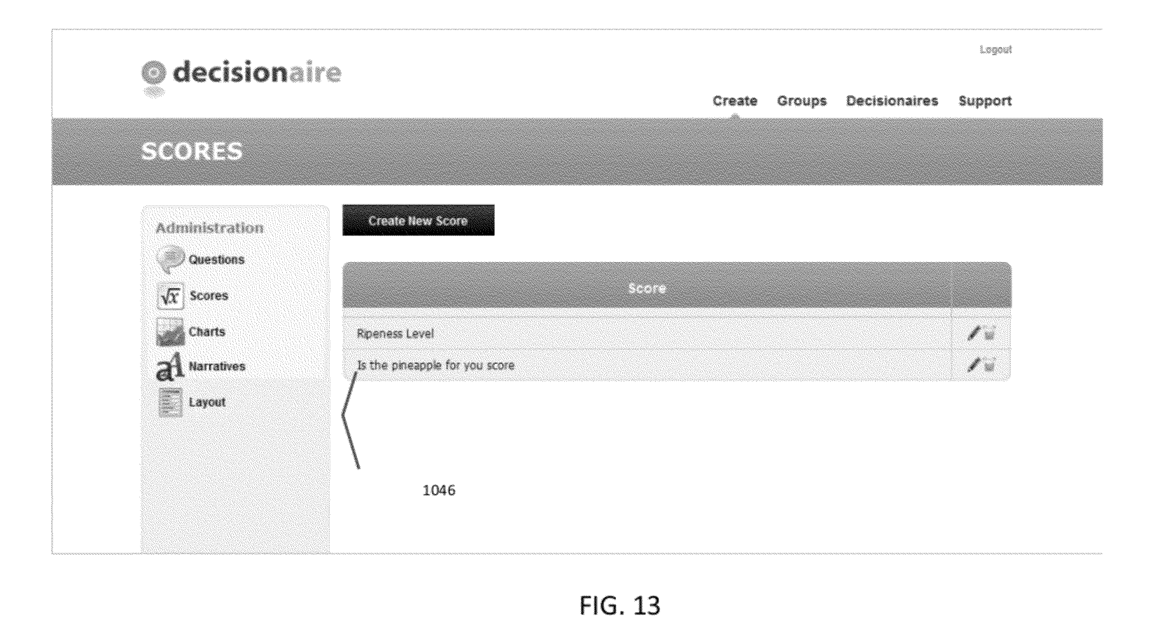

FIG. 13 shows a Scores screen that is presented after a “scores” icon is activated from the Administration menu at the left. In the Scores screen the author can create mathematical equations that are used to determine the tailored content that is automatically pulled together to draw a conclusion from the answer submitted. In this example, two conclusion equations (scores) are shown in a table 1046.

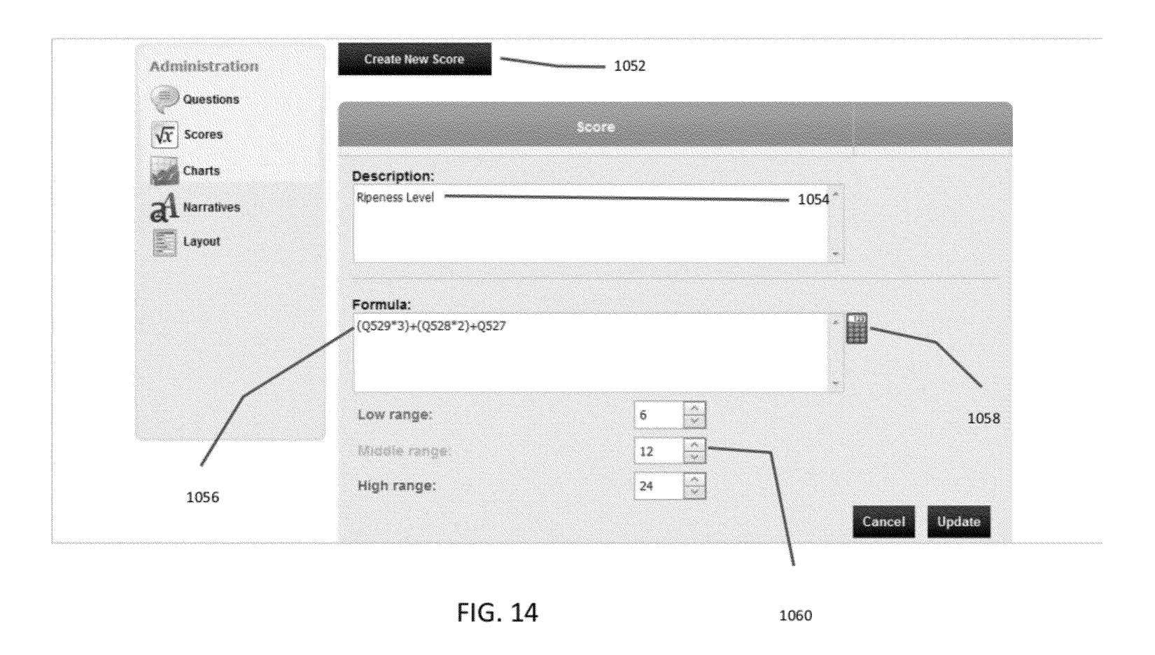

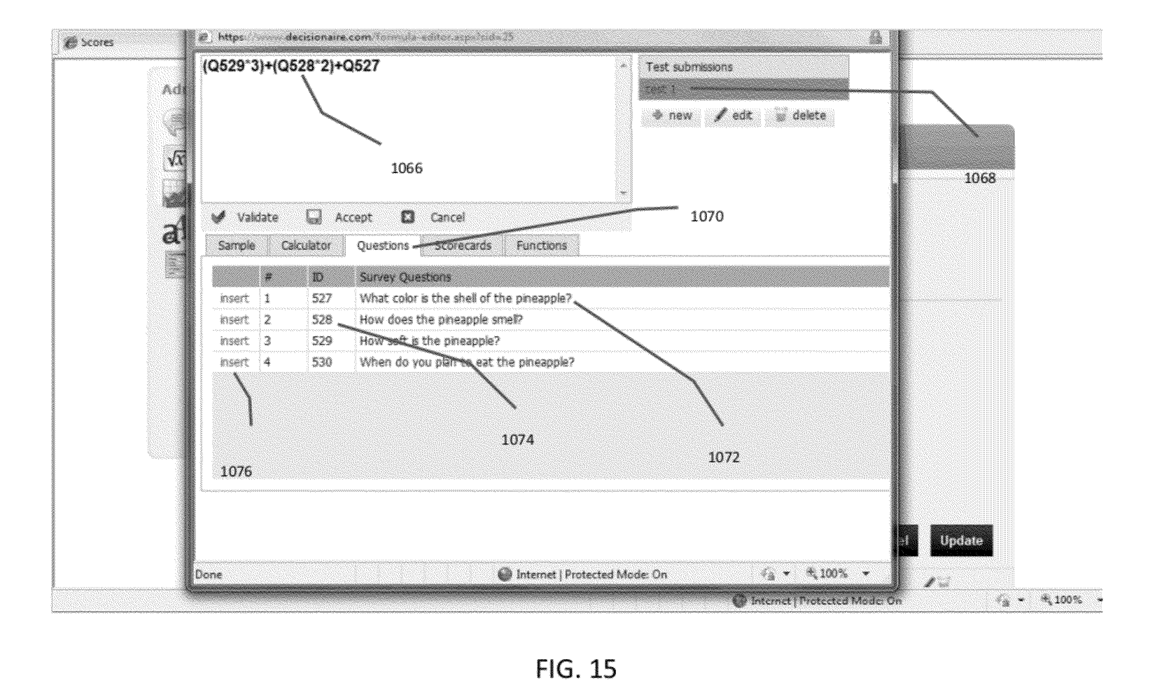

FIG. 14 shows a Score Edit/Create screen that is presented upon clicking either “Create New Score” button 1052 or the name of an existing score from the list 1046 of FIG. 13. In a description section 1054, the author names the score. In a formula section 1056, the author enters the desired formula. Activation of a calculator icon 1058 opens a formula/score creation/edit page—see FIG. 15. A range section 1060 allows the author to designate low, medium or high range for possible results of the formula.

FIG. 15 shows the formula/score creation/edit page. A created formula is shown in a formula window 1066. A number of tabs are displayed below the formula window 1066. The tabs include a questions tab 1070. When the questions tab 1070 is selected all the questions that have been entered are listed with name 1072 and identification number 1074. When the author wants to include one of the listed questions into the formula, the author selects the word insert 1076 that is adjacent to each question in the list.

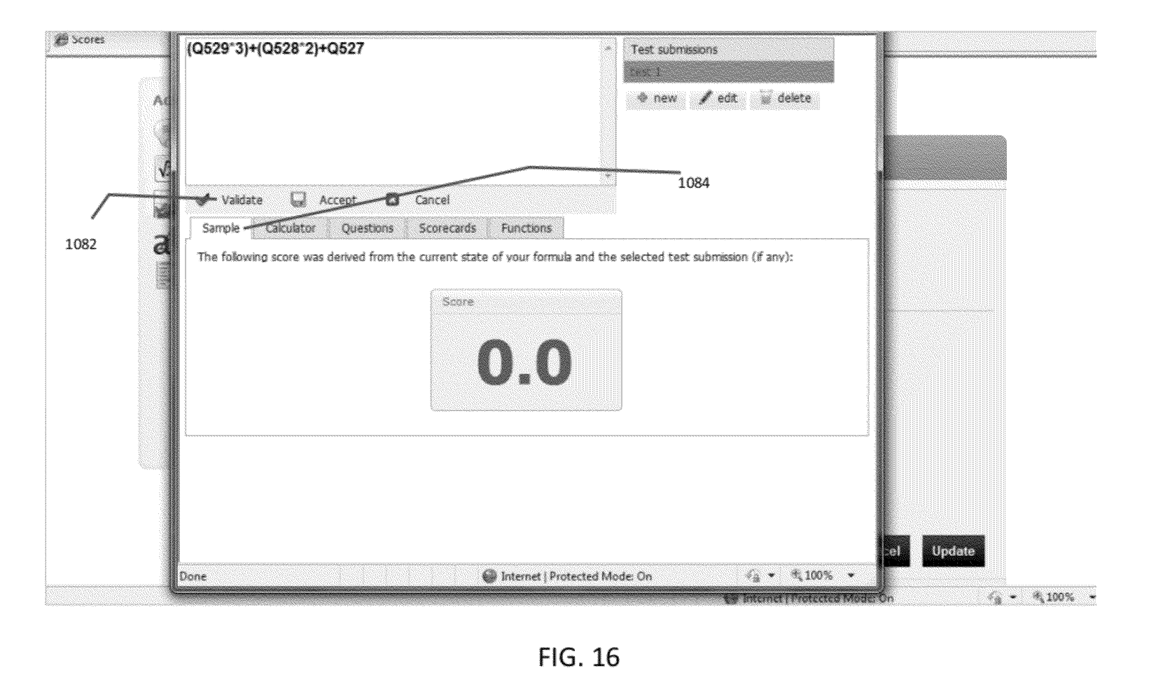

FIG. 16 shows contents of a sample tab 1084. When the sample tab 1084 is selected provides the information in a test submission is processed by the formula and the numeric answer is presented below in red. This is done to test the validity of the formula/score.

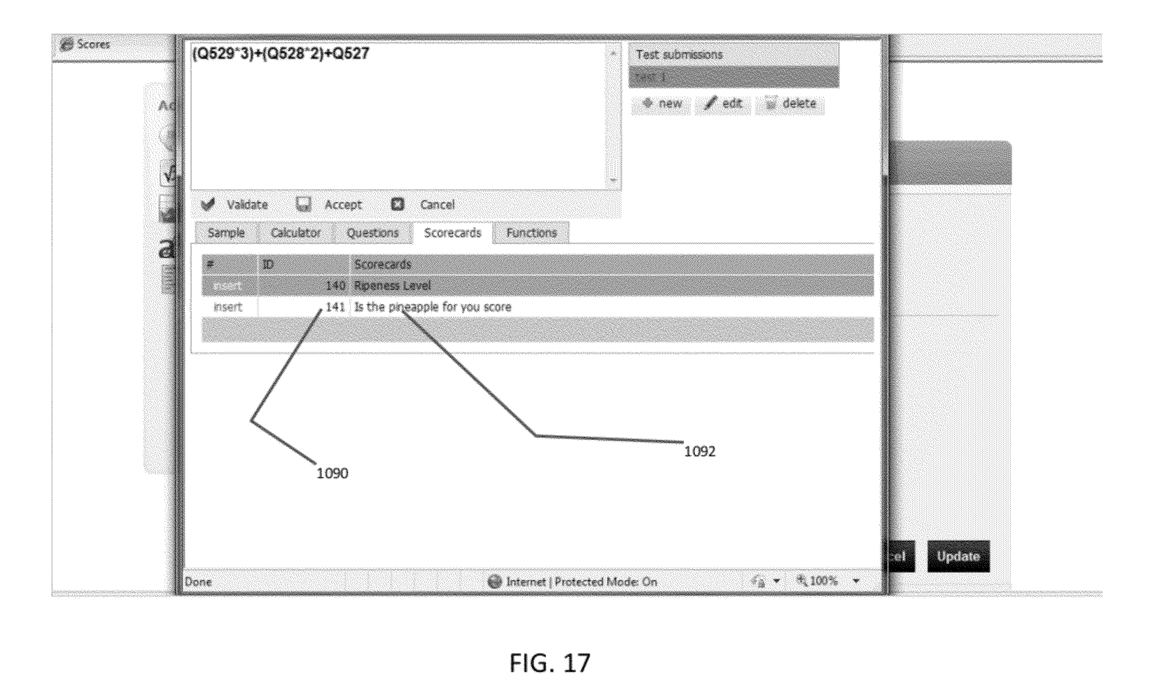

FIG. 17 shows the contents of a scorecard tab, which includes a list of formulas/scores that have been created 1092 with associated ID 1090. By clicking insert next to a score, the result of a selected formula/score is included into the formula/score that is being worked on.

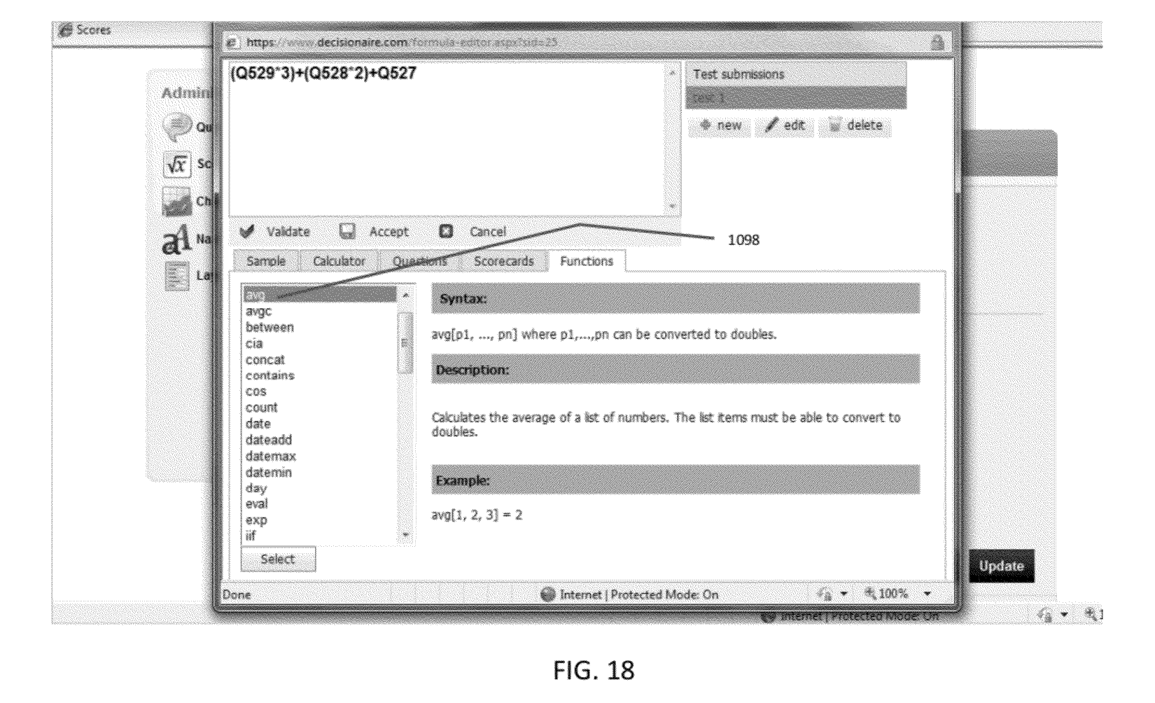

FIG. 18 shows a functions tab. The functions tab presents a list of different functions 1098 that one can use within a formula/score. The functions may be of various types. When a function is highlighted, syntax, description and example of the function are presented adjacent to the list 1098.

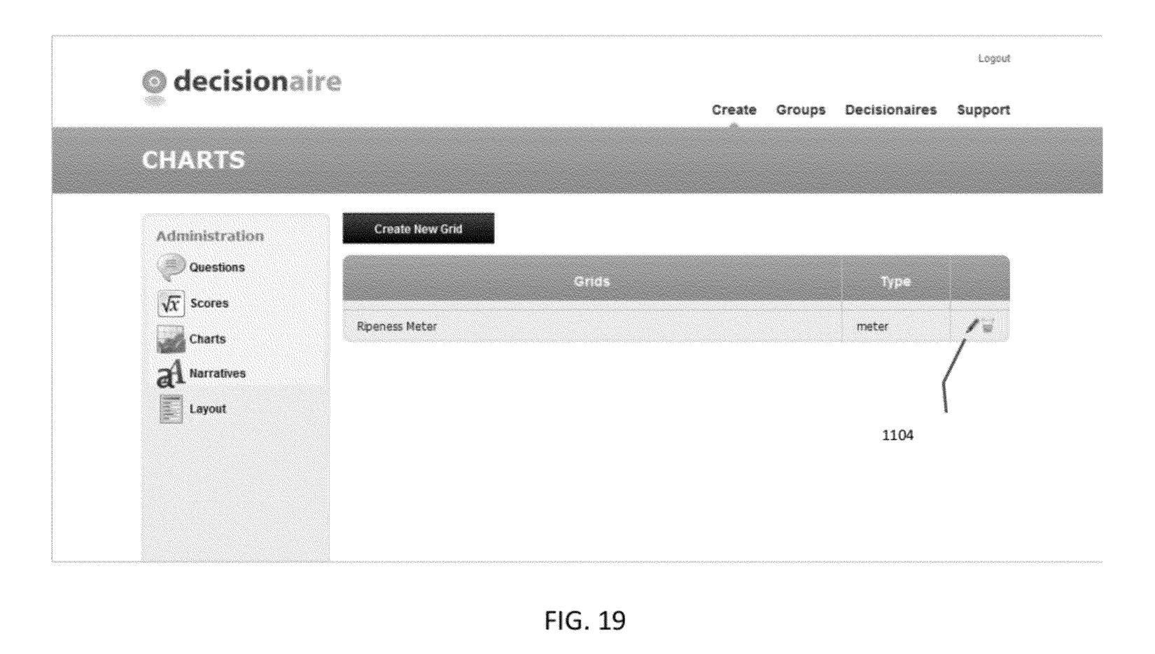

FIG. 19 shows a charts page when the author selects a “charts” icon on the left hand side of the screen. A new chart maybe created by activating a “Create New Grid” button or by selecting an edit icon 1104 located next to the name of an existing chart/grid in a chart table.

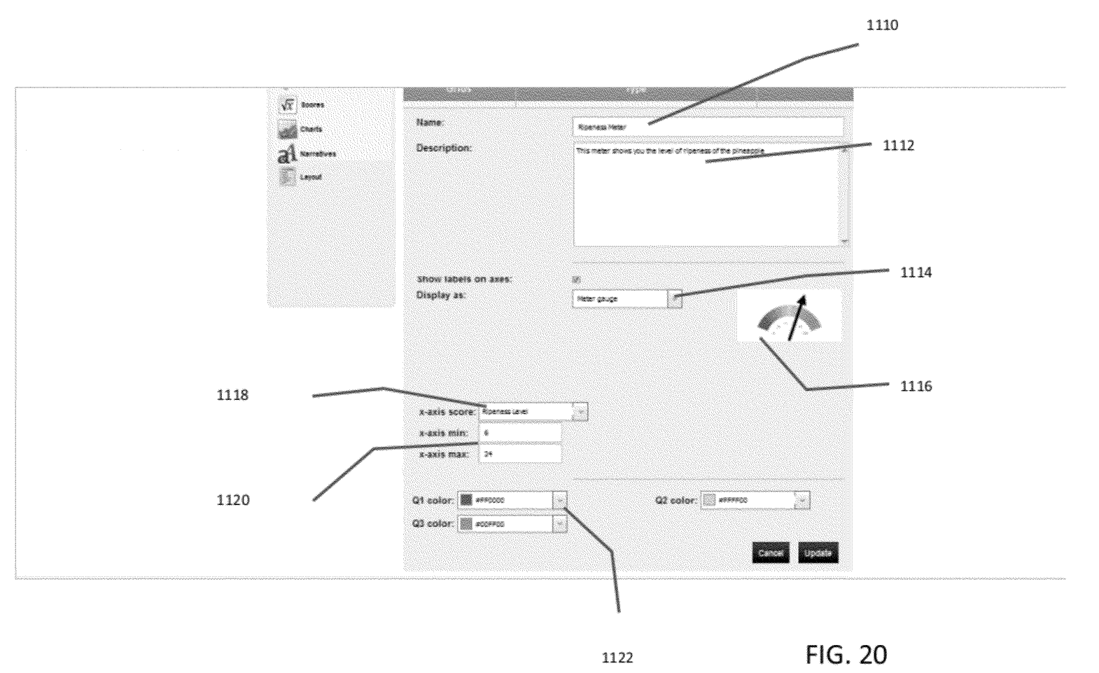

FIG. 20 shows a chart edit/creation page for creating a new chart/grid or editing an existing one. The author enters the grid name in a name field 1110 and a description of the grid in a description field 1112. The author selects the type of grid from a pull-down menu 1114. Once the author selects the grid an image 1116 of the grid is presented adjacent to the menu 1114. The author then assigns axis information for the grid. In this example, the grid is a meter gauge that includes only an x-axis. In a field 1118, the author selects the previously defined formula/score that is to provide the data for the associated axis. In this case, Ripeness Level formula will provide the data for the x-axis. The author then assigns max and min values for the grid at windows 1120. Below the axis information, is a chart color information section 1122, which allows the author to select colors for the chart, if applicable.

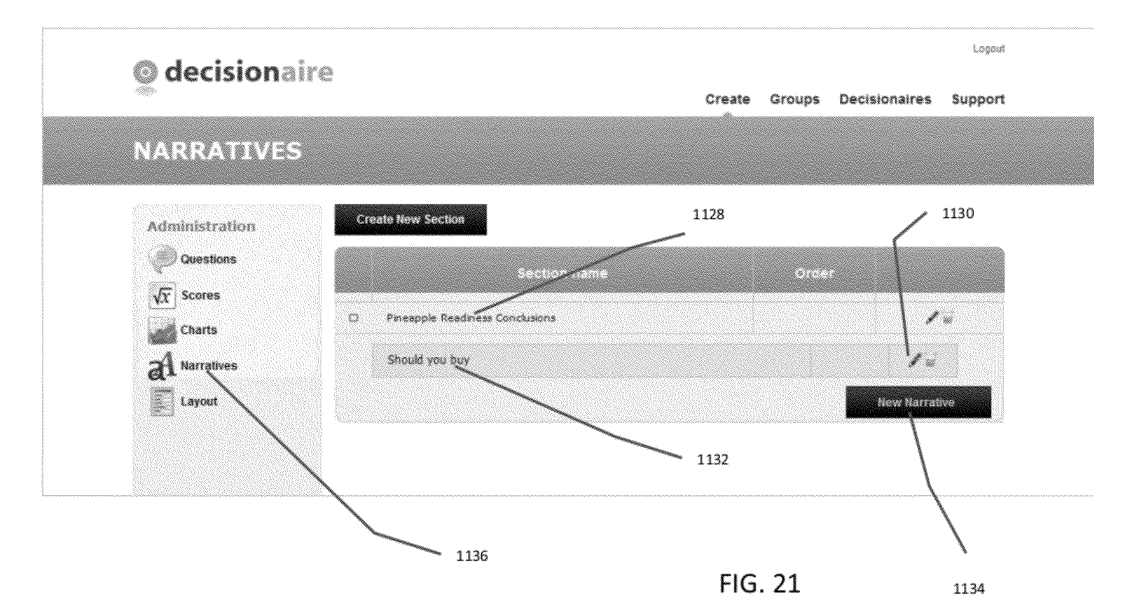

FIG. 21 shows a Narrative page that is presented upon activation of a “Narratives” icon 1136 located on the left hand side of the screen. Narratives are content that are automatically pulled together to construct a report or draw a conclusion from answer scores. In order to create a new narrative, the author activates a “New Narrative” button 1134, see FIG. 14. The Narrative page includes a table of narratives. The table includes a section name 1128 with the name of any associated narratives 1132. An Edit Narrative icon 130 allows the author to edit the associated narrative.

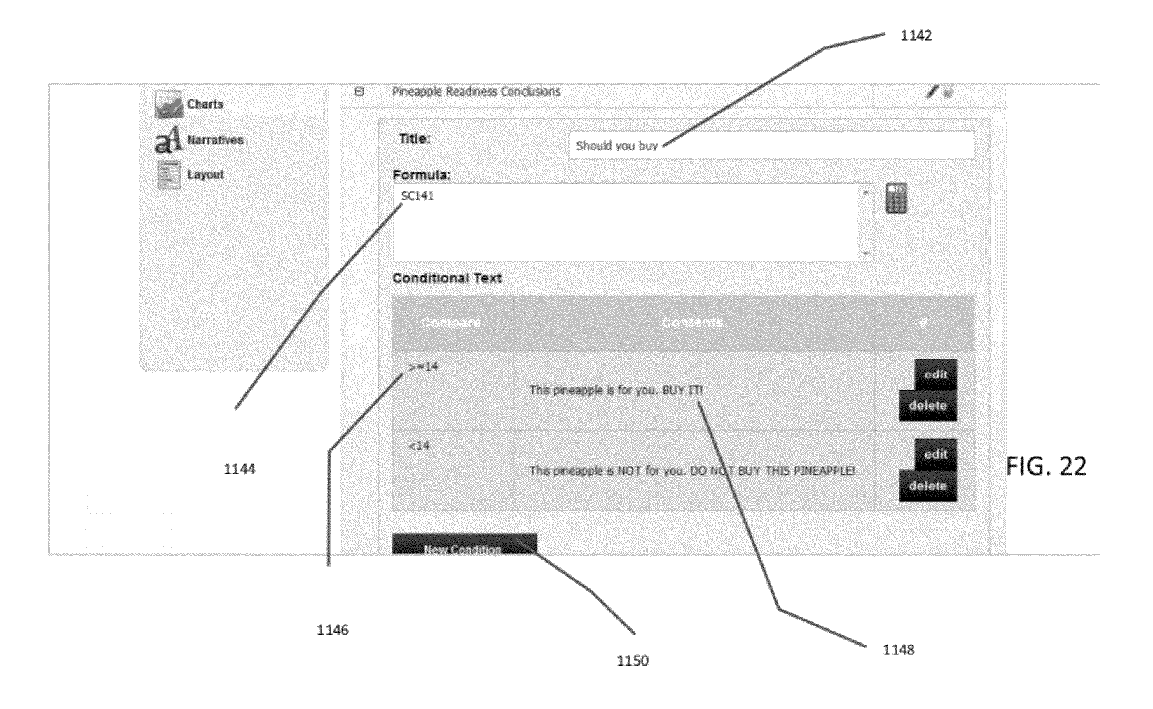

FIG. 22 shows a Narrative entry page. The title of the narrative is entered in a title section 1142. In a formula section 1144, the author enters the formula/score that the narrative is based on. In a conditional text section, the author enters a condition in a condition section 1146. The entered condition determines whether the narrative content entered into the adjacent content section 1148 is to be displayed in the associated report. Conditions are entered by selection of a new condition button 1150. In this example, if the result of the formula SC141 is greater than or equal to 14, then “The pineappleis for you. BUY IT!” is displayed to a user.

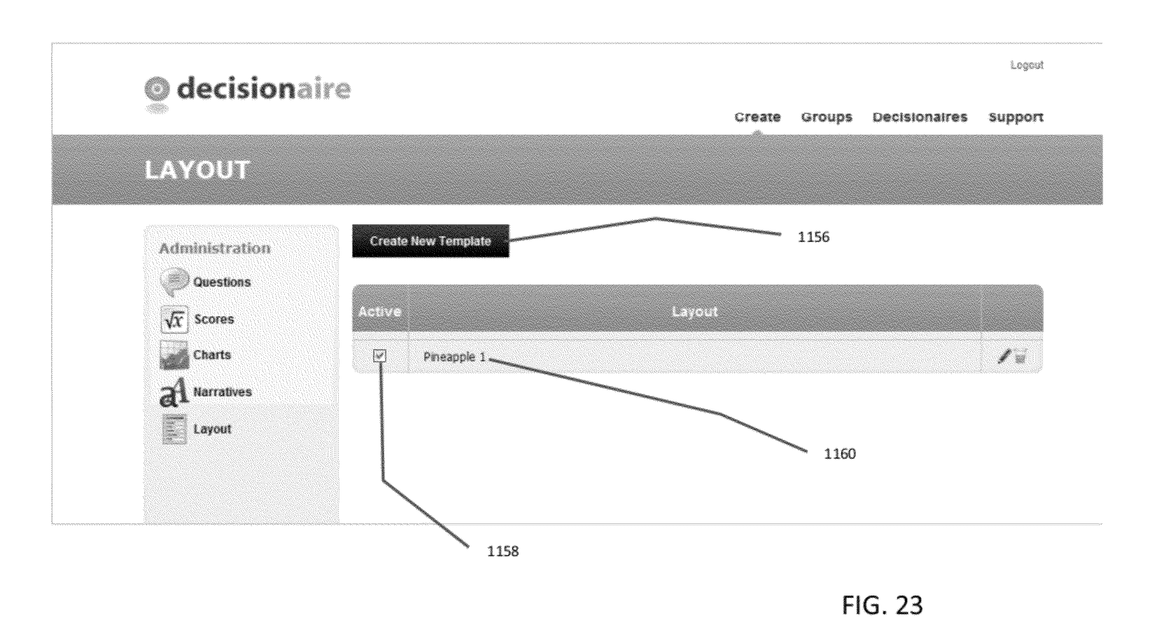

FIG. 23 shows a Layout page that is presented upon activation of a “Layout” icon below the Narratives icon. The layout functionality is used to establish how the report or conclusion drawn from the answers submitted is presented to the end user. A new layout is generated by activation of a create new template button 1156. The Layout page includes a table of created layout templates 1160. An active box adjacent to a layout template name is a box used to identify if the template is active and will be used in the automatic creation of a report. Only one template can be active at a time yet multiple templates may exist.

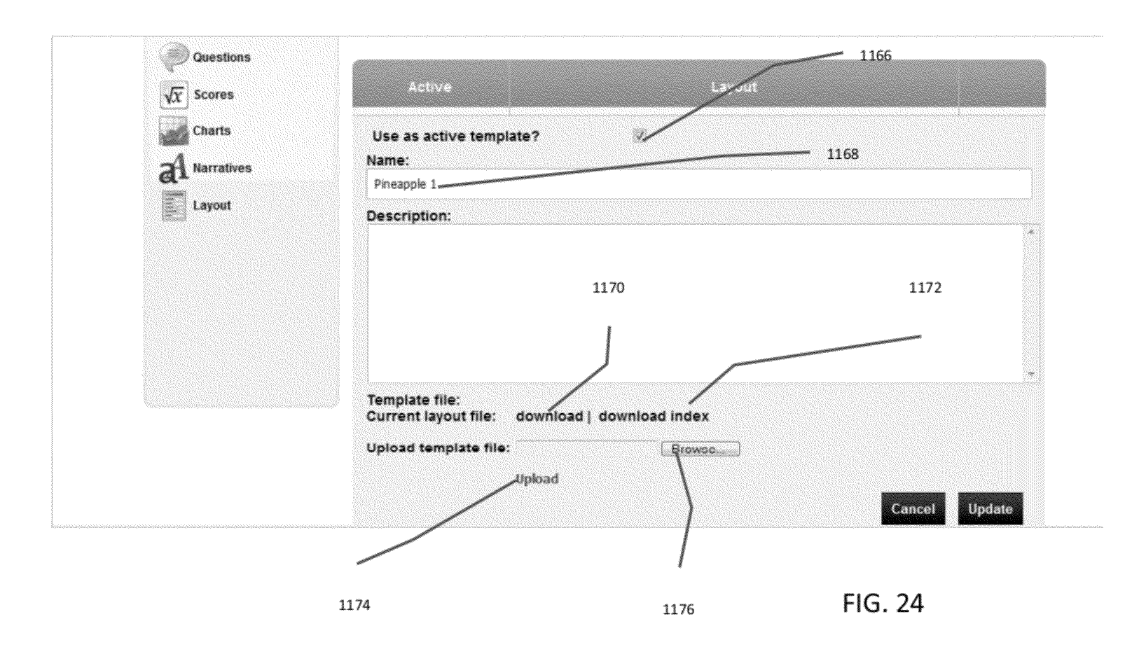

FIG. 24 shows a New Layout Template page presented upon activation of create new template button 1156 or by clicking an edit icon associated with an existing template. Templates can be either an HTML document or a Word doc. The New Layout Template page includes a box 1166 to identify if the template is active. A name section 1168 receives the name of the template. A description section receives a description of the template. The author can download the template using a download hyperlink 1170. The template is the word or HTML document layout of the report. This is what the report looks like. The index is a list of the macros that you place in your template to identify where narrative, graphs, etc are to be displayed. The author creates a template index by activating a download index hyperlink 1172. The template index includes a set of macros associated with scores, narratives, questions, and graphs. The author uses macros to specify where content appears in the user interface presented to an end user. The New Layout Template page also includes a file browser 1176 that allows the author to find a template file for uploading using an upload button 1174 for uploading the template/webpage to a host server over the network.

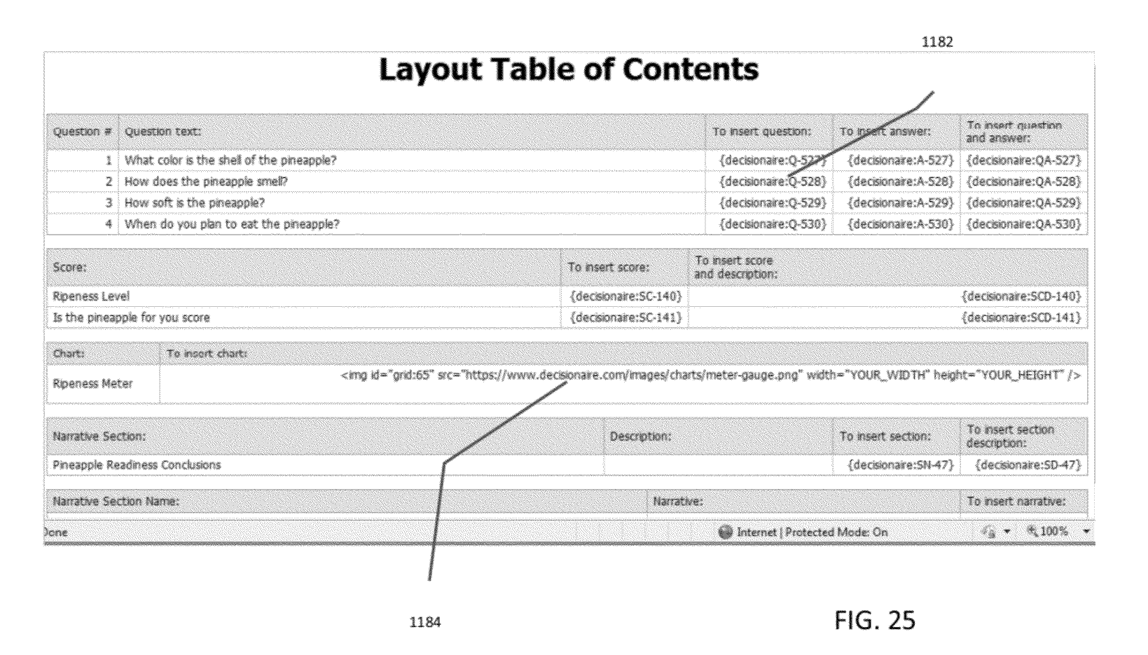

FIG. 25 shows a layout table of contents that is presented upon activation of “download index” hyperlink 1172. This is a list of the macros that you can insert into your report design template. The layout table of contents includes macros or commands that when processed by determines where to place graphs, narratives, etc within the automatically created report. A macro is a command. The author copies the related macro 1182 and places it into the webpage (HTML or Word doc). For example, {decisionaire:SC-141} is a macro that places the “is the pineapple for you” score in a specific location inside of the HTML or Word doc report design.

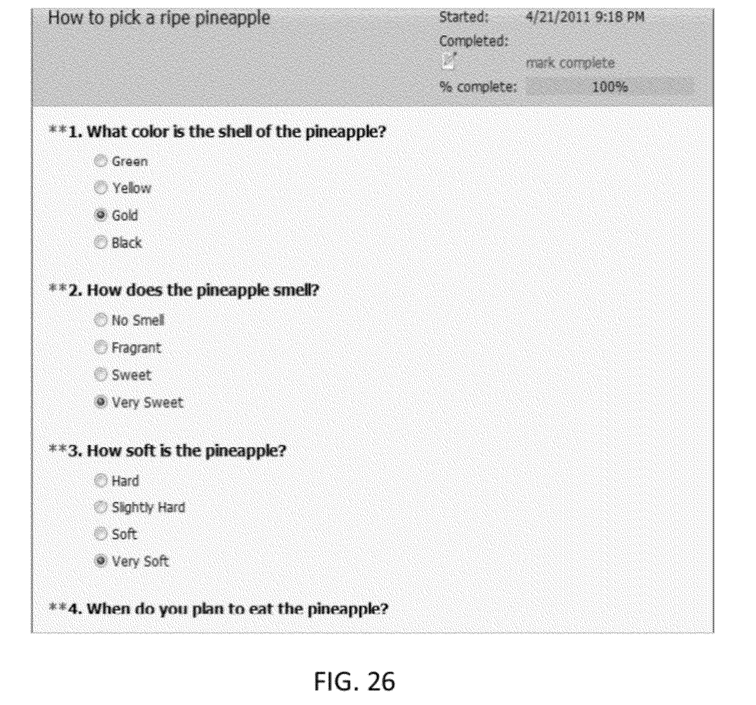

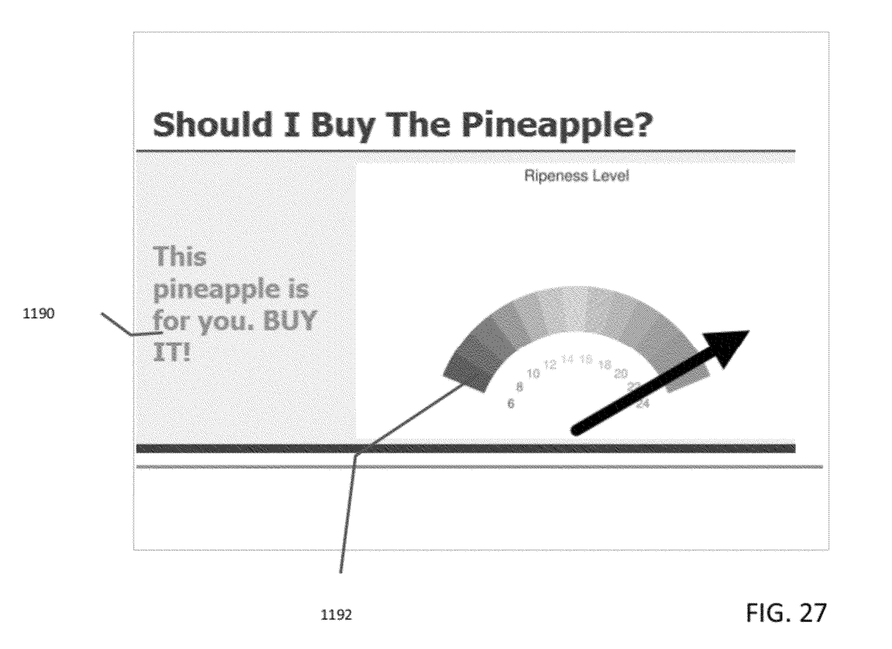

FIG. 26 shows the End-User Survey created by the author above. This survey is retrieved from a unique URL to provide end-users with access to the questionnaire/survey and the automatically generated report. FIG. 27 shows the results of a completed survey. The narrative 1190 and meter 1192 are presented according to the layout selected and the user's answers to the survey questions.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method of allowing an expert to provide expertise, comprising:
receiving, at a host provider computer, a questionnaire specification from the expert;
creating an intelligent questionnaire at the host provider computer on the basis of the questionnaire specification without requiring programming of the host provider computer by the expert;
if access rights to the intelligent questionnaire are distributed by the expert, allowing access to the intelligent questionnaire by an end user who has received the access rights,
wherein allowing access to the intelligent questionnaire comprises:
presenting, to the end user, questions in the intelligent questionnaire,
receiving, from the end user, answers to the questions,
associating an answer value to each of the answers, and
applying, to the answer values, at least one function defined in the questionnaire specification; and
providing one or more conclusions based on the answers.

2. The method of claim 1, wherein the questionnaire specification comprises:
at least one question to be answered by the end user;
at least one possible answer to one or more of the questions;
an answer value associated with each of the possible answers;
at least one function that, when applied to the answer values associated with the received answers, yields an output;
a library of at least one of a narrative or graphical element; and
a mapping of function outputs to the at least one narrative or graphical element.

3. The method of claim 2, further comprising:
dynamically retrieving at least one narrative or graphical element associated with the function output; and
constructing the one or more conclusions using the retrieved at least one narrative or graphical element.

4. The method of claim 2, wherein the questionnaire specification further comprises:
one or more parameters for the definition of a user interface through which the end user interacts with the intelligent questionnaire.

5. The method of claim 4, wherein the one or more parameters specify at least one of:
a question format in which questions are shown to the end user;
a sequence in which questions are shown to the end user; and
an answer interface in which answers are received from the end user.

6. The method of claim 1,
wherein said allowing of access by an end user is repeated for a plurality of end users, and
wherein the one or more conclusions reflect answers received from the plurality of end users.

7. The method of claim 1, wherein providing the one or more conclusions comprises providing the one or more conclusions to a user that is different than the plurality of end users.

8. A computer program product including a non-transitory computer readable medium having computer program logic stored therein for allowing an expert to provide expertise, the computer program logic comprising:
a logic component configured to cause a processor to receive a questionnaire specification from the expert;
a logic component configured to cause the processor to create an intelligent questionnaire at the host provider computer on the basis of the questionnaire specification without requiring programming of the host provider computer by the expert; and
a logic component configured to cause the processor to allow access to the intelligent questionnaire by an end user who has received the access rights where access rights to the intelligent questionnaire are distributed by the expert, wherein said logic to allow access to the intelligent questionnaire comprises:
a logic component configured to cause the processor to present, to the end user, questions in the intelligent questionnaire;
a logic component configured to cause the processor to receive, from the end user, answers to the questions;
a logic component configured to cause the processor to associate an answer value to each of the answers; and
a logic component configured to cause the processor to apply, to the answer values, at least one function defined in the questionnaire specification; and
a logic component configured to cause the processor to provide one or more conclusions based on the answers.

9. The computer program product of claim 8, wherein said distribution of access rights to the intelligent questionnaire comprises sale of the access rights.

10. The computer program product of claim 8, wherein the questionnaire specification comprises:
at least one question to be answered by the end user;
at least one possible answer to at least one of the questions;
an answer value associated with each of the possible answers;
at least one function that, when applied to the answer values associated with the received answers, yields an output;
a library of at least one of a narrative or graphical element; and
a mapping of function outputs to the at least one narrative and/or graphical element.

11. The computer program product of claim 10, the computer program logic further comprising:
a logic component configured to cause the processor to dynamically retrieving a narrative or graphical element associated with the function output; and
a logic component configured to cause the processor to construct the one or more conclusions using the retrieved narrative or graphical element.

12. The computer program product of claim 10, wherein the questionnaire specification further comprises:
one or more parameters for the definition of a user interface through which the end user interacts with the intelligent questionnaire.

13. The computer program product of claim 12, wherein the one or more parameters specify at least one of:
a question format in which questions are shown to the end user;
a sequence in which questions are shown to the end user; and
an answer interface in which answers are received from the end user.

14. The computer program product of claim 8,
wherein said allowing of access by an end user is repeated for a plurality of end users, and
wherein the one or more conclusions reflect answers received from the plurality of end users.

15. The computer program product of claim 8, wherein the logic component configured to cause the processor to provide one or more conclusions is configured to provide the one or more conclusions to a user that is different than the end user.

16. A method of allowing an expert to provide expertise, comprising:
receiving, at a host provider computer, a questionnaire specification from the expert;
creating an intelligent questionnaire on the basis of the questionnaire specification without requiring programming of the host provider computer by the expert; and
allowing access to the intelligent questionnaire to an end user, where the access is granted in exchange for a fee, wherein said allowing access comprises:
presenting, to the end user, questions in the intelligent questionnaire,
receiving, from the end user, answers to questions in the intelligent questionnaire,
associating an answer value to each of the answers,
applying, to the answer values, at least one function defined in the questionnaire specification, and
providing one or more conclusions based on the answers.

17. The method of claim 16, wherein at least a first portion of the fee is paid to a host provider, on whose host provider computer the intelligent questionnaire executes.

18. The method of claim 16, further comprising:
selling access rights to the intelligent questionnaire to an intermediate buyer, performed after said creating and before said allowing access;
wherein at least a second portion of the fee is paid to the intermediate buyer.

19. The method of claim 16, wherein the access to the intelligent questionnaire is provided to the end user by giving the end user a hypertext link to the intelligent questionnaire.

20. The method of claim 16, wherein the access to the intelligent questionnaire is provided to the end user by giving the end user information with which the end user can log on to the host provider computer.

21. The method of claim 16, wherein access to the intelligent questionnaire is allowed to a plurality of end users in exchange for the fee, such that the conclusions reflect answers received from the plurality of end users.

22. The method of claim 16, wherein the expert controls access to the intelligent questionnaire and determines the fees charged to the end users and to any intermediate buyers.

23. The method of claim 16, wherein access to the intelligent questionnaire is marketed to the end users in an on-line marketplace with a plurality of other intelligent questionnaires.

24. A system for allowing an expert to provide expertise, comprising:
a processor; and
a memory in communication with said processor, wherein said memory stores a plurality of processing instructions configured to direct said processor to:
receive, at a host provider computer, a questionnaire specification from the expert;
create an intelligent questionnaire at the host provider computer on the basis of the questionnaire specification without requiring programming of the host provider computer by the expert; and
if access rights to the intelligent questionnaire are distributed by the expert, allow access to the intelligent questionnaire by an end user who has received the access rights,
wherein allowing access to the intelligent questionnaire comprises:
presenting, to the end user, questions in the intelligent questionnaire,
receiving, from the end user, answers to the questions,
associating an answer value to each of the answers,
applying, to the answer values, at least one function defined in the questionnaire specification, and
providing one or more conclusions based on the answers.
